(19) United States
(12) Patent Application Publication
(10) Pub. No.: US 2016/0208158 A1
(43) Pub. Date: Jul. 21, 2016

(54) AMINE-BASED SHALE INHIBITOR AND METHODS FOR DRILLING, FRACTURING, AND WELL TREATMENT

(71) Applicant: INGEVITY SOUTH CAROLINA, LLC, North Charleston, SC (US)

(72) Inventors: Joseph A. Monahan, Mount Pleasant, SC (US); Reinaldo C. Navarrete, Houston, TX (US); Michael J. Skriba, Charleston, SC (US)

(21) Appl. No.: 14/915,586

(22) PCT Filed: Aug. 25, 2014
(86) PCT No.: PCT/US14/52549

§ 371 Date: Feb. 29, 2016

Related U.S. Application Data
(60) Provisional application No. 61/871,606, filed on Aug. 29, 2013.

(51) Int. Cl. C09K 8/60; E21B 43/16; C09K 8/68; E21B 43/26; C09K 8/06; C09K 8/035

(52) U.S. Cl. CPC C09K 8/607; C09K 8/06; C09K 8/035; C09K 8/68; E21B 43/26; E21B 43/16; C09K 2208/12

(57) ABSTRACT

A composition including triethylenetetramine and aminoethylpiperazine is used as a clay inhibitor in water-based drilling fluids and in hydraulic fracturing fluids for drilling wells and for fracturing subterranean formations, and is also used as a clay inhibitor in other treatment fluids for treating wells or subterranean formations.

### RELATED CASE

This application claims the benefit of U.S. Provisional Patent Application Ser. No. 61/871,606 filed on Aug. 29, 2013.

### FIELD OF THE INVENTION

The present invention relates to compositions for inhibiting clay swelling and to the use of such inhibitor compositions in drilling, fracturing, and other procedures.

### BACKGROUND OF THE INVENTION

A need exists for improved chemical formulations that are effective for inhibiting clay swelling, particularly when conducting drilling, fracturing, or other operations in shale formations. Shale formations are rich in clay content. They are horizontally drilled and then hydraulically fractured in multiple stages. Clay is by nature hydrophilic and in the presence of water absorbs water and swells. In some cases it may even disintegrate. During the drilling process, this may cause the well bore to cave or cause the drilling cuttings to disintegrate into fines, which cannot be removed easily from the recovered drilling fluid. During hydraulic fracturing, clay swelling may negatively affect production due to formation embedment in the proppant pack.

Water-based drilling fluids (muds) typically comprise a mixture of water and clay (e.g., bentonite) and also commonly include clay inhibitors and/or other chemicals. The drilling fluid is circulated through the well bore during drilling in order to lubricate and cool the drill bit, flush the cuttings out of the well, add stability to the walls of the well bore, and prevent cave-ins. Typically, the drilling fluid is delivered downwardly into the well through the drill string and then returns upwardly through the annulus formed between the drill string and the wall of the borehole.

Hydraulic fracturing fluids typically comprise water and sand, or other proppant materials, and also commonly include various types of chemical additives. Examples of such additives include: gelling agents which assist in suspending the proppant material; crosslinkers which help to maintain fluid viscosity at increased temperatures; gel breakers which operate to break the gel suspension after the fracture is formed and the proppant is in place; friction reducers; clay inhibitors; corrosion inhibitors; scale inhibitors; acids; surfactants; antimicrobial agents; and others. The hydraulic fracturing fluid is pumped into the subterranean formation under sufficient pressure to create, expand, and/or extend fractures in the formation and to thus provide enhanced recovery of the formation fluid.

### SUMMARY OF THE INVENTION

The present invention provides an inhibitor composition which is well suited for use in drilling and fracturing fluids and procedures of the type described above. The composition is surprisingly and unexpectedly effective for inhibiting clay swelling, costs less than current high performance inhibitors, and has a desirably low toxicity level. The inventive inhibitor and the inventive drilling and fracturing compositions produced therefrom are therefore particularly effective for use in drilling and fracturing shale formations.

The inhibitor composition is also well suited for use in other fluids and operations for treating wells or subterranean formations. Examples include, but are not limited to, completion fluids, water, polymer, surfactant, surfactant/polymer flood fluids, conformance control fluids, and work over or other well treatment fluids.

In one aspect, there is provided a method of drilling a well wherein a water-based drilling fluid is circulated through a well bore as the well bore is being drilled. The improvement to the method comprises the water-based drilling fluid including an inhibitor composition comprising: (a) triethylenetetramine (TETA) in an amount of from about 45% to about 90% by weight of the total weight of the inhibitor composition and (b) aminoethylpiperazine (AEP) in an amount of from about 5% to about 50% by weight of the total weight of the inhibitor composition.

In another aspect, the improvement to the method of drilling a well preferably further comprises the inhibitor composition also including: (c) diethylenetriamine (DETA) in an amount of from 0% to about 15% by weight of the total weight of the inhibitor composition; (d) tetraethylenepentamine (TEPA) in an amount of from about 1% to about 15% by weight of the total weight of the inhibitor composition; (e) aminoethylethanolamine (AEEA) in an amount of from about 0.1% to about 10% by weight of the total weight of the inhibitor composition; and (f) 2-piperazinoethanol in an amount of from 0% to about 10% by weight of the total weight of the inhibitor composition.

In another aspect, there is provided a method of fracturing a subterranean formation comprising injecting a fracturing fluid into the subterranean formation. The improvement to the method of fracturing comprises the fracturing fluid including an inhibitor composition comprising: (a) triethylenetetramine (TETA) in an amount of from about 45% to about 90% by weight of the total weight of the inhibitor composition and (b) aminoethylpiperazine (AEP) in an amount of from about 5% to about 50% by weight of the total weight of the inhibitor composition.

In another aspect, the improvement to the method of fracturing a subterranean formation preferably further comprises the inhibitor composition also including: (c) diethylenetriamine (DETA) in an amount of from 0% to about 15% by weight of the total weight of the inhibitor composition; (d) tetraethylenepentamine (TEPA) in an amount of from about 1% to about 15% by weight of the total weight of the inhibitor composition; (e) aminoethylethanolamine (AEEA) in an amount of from about 0.1% to about 10% by weight of the total weight of the inhibitor composition; and (f) 2-piperazinoethanol in an amount of from 0% to about 10% by weight of the total weight of the inhibitor composition.

In another aspect, there is provided a method of treating a well or a subterranean formation wherein a treatment fluid is injected into the well or subterranean formation. The improvement to the method of treating a well or subterranean formation comprises the treatment fluid also including an inhibitor composition comprising: (a) triethylenetetramine (TETA) in an amount of from about 45% to about 90% by weight of the total weight of the inhibitor composition and (b) aminoethylpiperazine (AEP) in an amount of from about 5% to about 50% by weight of the total weight of the inhibitor composition.

In another aspect, the improvement to the method of treating a well or subterranean formation preferably further comprises the inhibitor composition also including: (c) diethylenetriamine (DETA) in an amount of from 0% to about 15% by weight of the total weight of the inhibitor composition; (d) tetraethylenepentamine (TEPA) in an amount of from about 1% to about 15% by weight of the total weight of the inhibitor composition; (e) aminoethylethanolamine (AEEA) in an amount of from about 0.1% to about 10% by weight of the total weight of the inhibitor composition; and (f) 2-piperazinoethanol in an amount of from 0% to about 10% by weight of the total weight of the inhibitor composition.

Further aspects, features, and advantages of the present invention will be apparent to those of ordinary skill in the art upon examining the accompanying drawings and upon reading the following Detailed Description of the Preferred Embodiments.

### BRIEF DESCRIPTION OF THE DRAWINGS

FIG. 1 is a graph showing Capillary Suction Time (CST) test results for an inhibitor composition of the present invention as compared to various prior art inhibitors.

FIG. 2 is a graph showing shale dispersion test results, at drilling fluid concentrations, for an inhibitor composition of the present invention as compared to various prior art inhibitors.

FIG. 3 is a graph showing shale dispersion test results, at fracturing fluid concentrations, for an inhibitor composition of the present invention as compared to various prior art inhibitors.

### DETAILED DESCRIPTION OF THE PREFERRED EMBODIMENTS

The present invention provides improved inhibitor compositions and methods for drilling wells, fracturing subterranean formations, and other treatments. The inventive drilling and fracturing compositions and methods are particularly effective for use in shale formations but can also be used in generally any other type of formation.

In the inventive drilling method, a water-based drilling fluid including an inhibitor composition provided by the present invention is circulated through the well bore as the well is being drilled. In the inventive fracturing method, a fracturing fluid including the inhibitor composition provided by the present invention is injected into a subterranean formation, preferably under sufficient pressure to create, expand, and/or extend fractures in the formation and to thereby provide enhanced recovery of the formation fluid.

Similarly, in other treatment methods provided by the present invention for treating wells or subterranean formations, a treatment fluid including a sufficient amount of the inhibitor composition provided by the present invention to at least reduce clay swelling is injected into the well or formation. Examples of such treatment operations include, but are not limited to, completions, flooding, conformist control, stimulation, enhanced recovery, and anti-accretion.

In each of the embodiments described herein, the inhibitor composition provided and used in accordance with the present invention preferably comprises: (a) triethylenetetramine (TETA) in an amount of from about 45% to about 90% by weight of the total weight of the inhibitor composition and (b) aminoethylpiperazine (AEP) in an amount of from about 5% to about 50% by weight of the total weight of the inhibitor composition. More preferably, the inhibitor composition comprises from about 50% to about 80% TETA and from about 5% to about 45% AEP.

The inhibitor composition also preferably comprises one or more of the following components (as expressed in percentages by weight based upon the total weight of the inhibitor composition):
Diethylenetriamine (DETA): 0% to about 15% (more preferably either (a) from 0% to about 10% or (b) from at least about 0.1% to about 10%);
Tetraethylenepentamine (TEPA): about 1% to about 15% (more preferably from about 2% to about 10%);
Aminoethylethanolamine (AEEA): about 0.1% to about 10% (more preferably form about 0.1% to about 5%); and
2-Piperazinoethanol: 0% to about 10% (more preferably either (a) from 0% to about 5% or (b) from at least about 0.1% to about 5%).

By way of example, but not by way of limitation, a preferred example of the inhibitor composition used in the present invention is the chemical composition having Chemical Abstracts Service (CAS) Registry No. 84238-53-9. This composition is a distillation residuum by-product which remains following the fraction of a reaction product mixture produced by reacting 2-aminoethanol with ammonia.

As will be shown below, this distillation residuum bottoms composition is surprisingly and unexpectedly effective for use as a clay inhibitor composition for drilling, fracturing, or other operations. Heretofore, to our knowledge, although it has been suggested that the distillation residuum bottoms composition could be used as an intermediate in the manufacture of asphalt additives or in polyamide resins or corrosion inhibitors, the residuum bottoms composition has largely been treated as a waste product.

The distillation residuum bottoms composition classified as CAS Reg. No. 84238-53-9 comprises the following components expressed in percentages by weight of the total weight of the CAS 84238-53-9 composition:
50% to 80% TETA;
5% to 45% AEP;
0% to 10% DETA;
2% to 10% TEPA;
0.1% to 5% AEEA;
0% to 5% 2-Piperazinoethanol; and
0% to 1% Higher ethyleneamines

CAS Reg. No. 84238-53-9 also has: an estimated boiling point (760 mmHg) of 251° C.; an estimated flashpoint (closed cup) of 108° C.; an estimated vapor pressure of less than 0.01 mmHg at 20° C.; an estimated vapor density (air=1) of 4.5; an estimated specific gravity (water=1) of 0.9835; an estimated solubility in water of 100% by weight at 20° C.; a pH (1% aqueous solution) of 11.5; and a calculated viscosity of 17 mm²/sec at 20° C.

In the inventive drilling method, the inhibitor composition provided by the present invention will preferably be used in the water-based drilling fluid in an amount effective to at least reduce clay swelling occurring in the well as the drilling fluid is circulated through the well bore. The inhibitor composition will more preferably be used in an amount in the range of from about 0.5% to about 7% by weight and will most preferably be used in amount of from about 1% to about 5% by weight, based upon the total weight of the water-based drilling fluid.

In the inventive fracturing method, the inhibitor composition provided by the present invention will preferably be used in the hydraulic fracturing fluid in an amount effective to at least reduce clay swelling occurring in the subterranean formation when the fracturing fluid is injected. The inhibitor composition will more preferably be used in an amount in the range of from about 0.01% to about 1% by weight and will most preferably be used in an amount in the range of from about 0.05% to about 0.5% by weight, based upon the total weight of the hydraulic fracturing fluid.

The following examples are meant to illustrate, but in no way limit, the claimed invention.

### EXAMPLE 1

The suitability of the CAS Reg. No. 84238-53-9 composition for use as a clay inhibitor in water-based drilling and fracturing fluids was evaluated using a Capillary Suction Timer (CST). For testing, the CAS 84238-53-9 material was mixed with tap water for 10 minutes in a Hamilton Beach mixer to make a 0.05% wt. solution and a 0.1% wt. solution of inhibitor in water. Next, 50 g of IPA Bentonite clay was added over one minute to each inhibitor solution and the mixtures were stirred for 90 minutes at room temperature.

For comparison purposes, mixtures of three well-known high performance inhibitors currently used in the art were prepared using the same procedure. The prior art inhibitors were tetramethylammonium chloride (TMAC), choline chloride (CC), and potassium chloride (KCl). Specifically, the aqueous prior art inhibitor solutions used in the comparison mixtures were: 0.05 wt % and 0.1 wt % TMAC; 0.07 wt %, 0.14 wt %, and 0.2 wt % CC; and 2 wt % and 6 wt % KCl. A “blank” mixture using water only with no inhibitor was also tested.

In testing samples of each of these mixtures, an OFI CST 294-50 instrument using Whatman 17 Standard CST paper was first prepared by cleaning the electrodes of the instrument and replacing the CST paper. A transfer pipet was then used to pull a 2 mL sample of the mixture and inject the sample into the center of the CST device. The capillary action movement of the liquid mixture was then measured in terms of the time required for the sample front to move from the first electrode to the second electrode. The time was recorded and the test was then repeated four additional times for each test mixture.

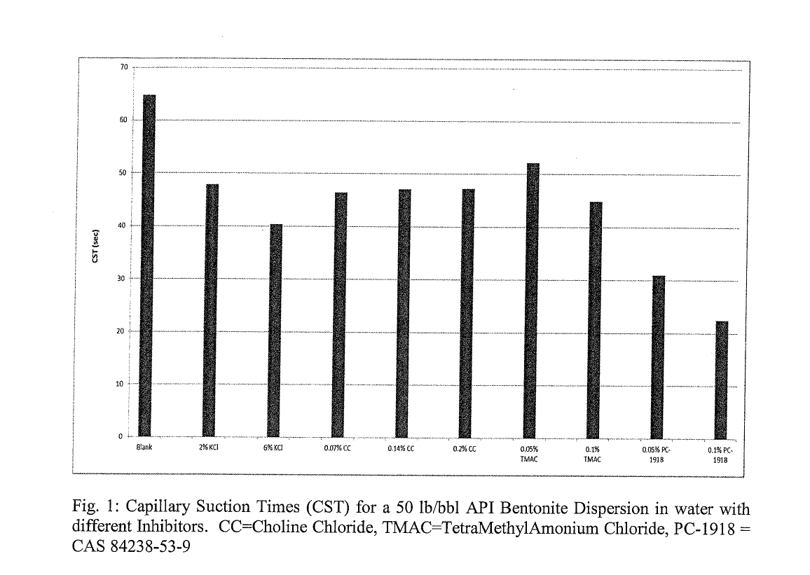

The time results of the CST tests are shown in FIG. 1. All results recorded in FIG. 1 are in seconds. In FIG. 1, the CAS 84238-53-9 samples are identified as “0.05% PC-1918” and “0.1% PC-1918”.

The results show that the inventive CAS 84238-53-9 samples significantly outperformed the prior art inhibitors in the CST tests. In fact, the CST time of the 0.1 wt % CAS 84238-53-9 sample (designated as “0.1% PC-1918” in FIG. 1) was surprisingly one-half or close to one-half of the of the best CST time provided by each of the prior art inhibitors.

### EXAMPLE 2

Comparative dispersion tests for the inventive inhibitor versus various prior art inhibitors were conducted by first passing shale samples through a Combustion Engineering U.S.A Standard Testing 16-mesh sieve. Small particulates that passed through the sieve were discarded. The larger pieces were placed into a 250 mL beaker.

Inhibitor solutions of varying concentrations were prepared by adding the inhibitor to pre-weighed 1 L bottles. Tap water was then added and the bottles were shaken to homogenize the mixtures. The inhibitor solutions prepared for testing included (a) a 3 wt % solution of the inventive CAS 84238-53-9 inhibitor (3% PC-1918) and (b) a set of comparative 3 wt % solutions of the high performance prior art inhibitors tetramethylammonium chloride (TMAC), choline chloride (CC), and Jeffamine D-230. Additional inhibitor solutions prepared for testing were: (1) 0.07 wt % and 0.14 wt % solutions of the inventive CAS 84238-53-9 inhibitor (0.07% PC-1918 and 0.14% PC-1918); (2) 2 wt % and 6 wt % solutions of potassium chloride (KCl); (3) 0.07 wt % and 0.14 wt % solutions of TMAC; and (4) a 10 wt % solution of NaCl.

For each of these inhibitor solutions, 21.0 g of relatively uniform shale pieces from the 250 mL beaker and 234.0 g of the inhibitor solution were placed in a 260 mL pressure cell and the cell was pressurized with 100 psi of nitrogen.

Each inhibitor solution was tested in triplicate, totaling three pressure cells per inhibitor. The cells were placed in a pre-heated roller oven and initially rolled for 16 hours. The cells were cooled in a water bath and the contents of the cells were collected on the 16-mesh sieve and dried. For each inhibitor solution, the mass percentage of shale retained was then calculated by dividing the dried shale weight collected from the sieve by the initial weight of the sample and multiplying by 100.

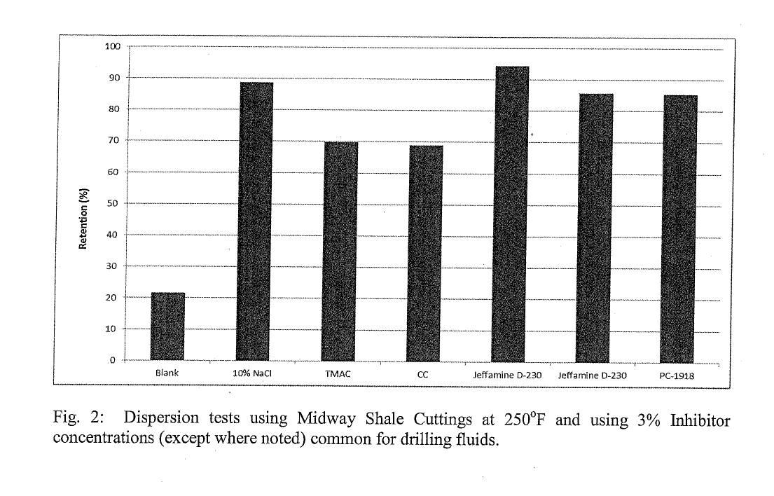

FIG. 2 shows the dispersion tests results comparing the inventive 3 wt % CAS 84238-53-9 inhibitor (PC-1918) with the prior art 3 wt % solutions of TMAC, CC, and Jeffamine D-230 and the 10 wt % NaCl solution which have commonly been used heretofore at these concentrations as inhibitors in water-based drilling fluids. The inventive CAS 84238-53-9 inhibitor (PC-1918) demonstrated a very high degree of retention close to that of Jeffamine D-230, which is considered a high end shale inhibitor for drilling fluids. It also compared well with the 10 wt % NaCl solution, a high concentration of salt.

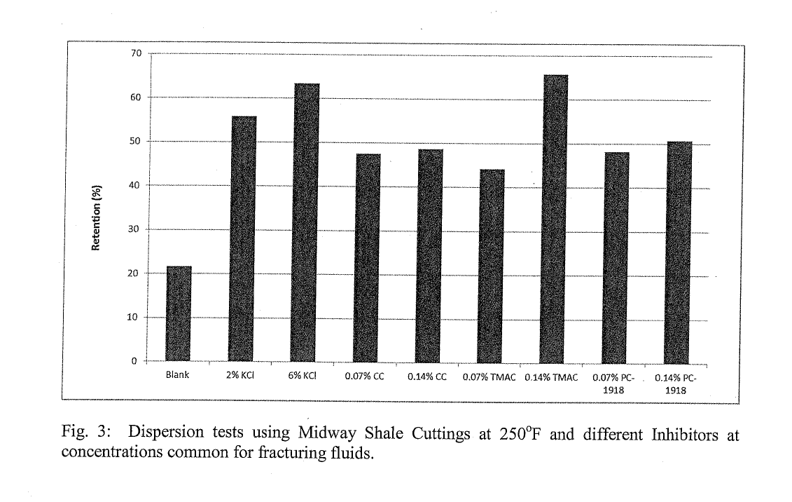

FIG. 3 shows the dispersion test results for different inhibitors at much lower inhibitor concentrations, typical of Fracturing Fluids. The performance of the inventive CAS 84238-53-9 inhibitor (PC-1918) was very similar to that of Choline Chloride, an inhibitor that is widely used in Fracturing Fluids.

Thus, the present invention is well adapted to carry out the objects and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within this invention as defined by the claims.

What is claimed is:

1. A clay inhibitor composition for fluids used in drilling, fracturing, or treating wells and subterranean formations, said clay inhibitor composition comprising:
triethylenetetramine (TETA) in an amount of from about 45% to about 90% by weight of a total weight of said clay inhibitor composition and
aminoethylpiperazine (AEP) in an amount of from about 5% to about 50% by weight of said total weight of said inhibitor composition.

2. The clay inhibitor composition of claim 1 further comprising:
tetraethylenepentamine (TEPA) in an amount of from about 1% to about 15% by weight of said total weight of said clay inhibitor composition and
aminoethylethanolamine (AEEA) in an amount of from about 0.1% to about 10% by weight of said total weight of said clay inhibitor composition.

3. The clay inhibitor composition of claim 2 wherein:
said triethylenetetramine (TETA) is present in said clay inhibitor composition in an amount of from about 50% to about 80% by weight of said total weight of said clay inhibitor composition and
said aminoethylpiperazine (AEP) is present in said clay inhibitor composition in an amount of from about 5% to about 45% by weight of said total weight of said clay inhibitor composition.

4. The clay inhibitor composition of claim 3 wherein:
said tetraethylenepentamine (TEPA) is present in said clay inhibitor composition in an amount of from about 2% to about 10% by weight of said total weight of said clay inhibitor composition and
said aminoethylethanolamine (AEEA) is present in said clay inhibitor composition in an amount of from about 0.1% to about 5% by weight of said total weight of said clay inhibitor composition.

5. The clay inhibitor composition of claim 3 further comprising diethylenetriamine (DETA) in an amount of from about 0.1% to about 15% by weight of said total weight of said clay inhibitor composition.

6. The clay inhibitor composition of claim 3 further comprising 2-piperazinoethanol in an amount of from about 0.1% to about 10% by weight of said total weight of said clay inhibitor composition.

7. A method of drilling a well comprising circulating a water-based drilling fluid through a well bore as said well bore is being drilled, wherein said water-based drilling fluid includes an inhibitor composition comprising:
triethylenetetramine (TETA) in an amount of from about 45% to about 90% by weight of a total weight of said inhibitor composition and
aminoethylpiperazine (AEP) in an amount of from about 5% to about 50% by weight of said total weight of said inhibitor composition.

8. The method of claim 7 wherein said inhibitor composition further comprises:
tetraethylenepentamine (TEPA) in an amount of from about 1% to about 15% by weight of said total weight of said inhibitor composition and
aminoethylethanolamine (AEEA) in an amount of from about 0.1% to about 10% by weight of said total weight of said inhibitor composition.

9. The method of claim 8 wherein:
said triethylenetetramine (TETA) is present in said inhibitor composition in an amount of from about 50% to about 80% by weight of said total weight of said inhibitor composition and
said aminoethylpiperazine (AEP) is present in said inhibitor composition in an amount of from about 5% to about 45% by weight of said total weight of said inhibitor composition.

10. The method of claim 8 wherein:
said tetraethylenepentamine (TEPA) is present in said inhibitor composition in an amount of from about 2% to about 10% by weight of said total weight of said inhibitor composition and
said aminoethylethanolamine (AEEA) is present in said inhibitor composition in an amount of from about 0.1% to about 5% by weight of said total weight of said inhibitor composition.

11. The method of claim 8 wherein said inhibitor composition further comprises diethylenetriamine (DETA) in an amount of from about 0.1% to about 15% by weight of said total weight of said inhibitor composition.

12. The method of claim 8 wherein said inhibitor composition further comprises 2-piperazinoethanol in an amount of from about 0.1% to about 10% by weight of said total weight of said inhibitor composition.

13. A method of fracturing a subterranean formation comprising injecting a fracturing fluid into said subterranean formation, wherein said fracturing fluid includes an inhibitor composition comprising:
triethylenetetramine (TETA) in an amount of from about 45% to about 90% by weight of a total weight of said inhibitor composition and
aminoethylpiperazine (AEP) in an amount of from about 5% to about 50% by weight of said total weight of said inhibitor composition.

14. The method of claim 13 wherein said inhibitor composition further comprises:
tetraethylenepentamine (TEPA) in an amount of from about 1% to about 15% by weight of said total weight of said inhibitor composition and
aminoethylethanolamine (AEEA) in an amount of from about 0.1% to about 10% by weight of said total weight of said inhibitor composition.

15. The method of claim 14 wherein:
said triethylenetetramine (TETA) is present in said inhibitor composition in an amount of from about 50% to about 80% by weight of said total weight of said inhibitor composition and
said aminoethylpiperazine (AEP) is present in said inhibitor composition in an amount of from about 5% to about 45% by weight of said total weight of said inhibitor composition.

16. The method of claim 15 wherein:
said tetraethylenepentamine (TEPA) is present in said inhibitor composition in an amount of from about 2% to about 10% by weight of said total weight of said inhibitor composition and
said aminoethylethanolamine (AEEA) is present in said inhibitor composition in an amount of from about 0.1% to about 5% by weight of said total weight of said inhibitor composition.

17. The method of claim 15 wherein said inhibitor composition further comprises diethylenetriamine (DETA) in an amount of from about 0.1% to about 15% by weight of said total weight of said inhibitor composition.

18. The method of claim 15 wherein said inhibitor composition further comprises 2-piperazinoethanol in an amount of from about 0.1% to about 10% by weight of said total weight of said inhibitor composition.

19. A method of treating a well or a subterranean formation comprising injecting a treatment fluid into said well or said subterranean formation, wherein said treatment fluid includes an inhibitor composition comprising:
triethylenetetramine (TETA) in an amount of from about 45% to about 90% by weight of a total weight of said inhibitor composition and
aminoethylpiperazine (AEP) in an amount of from about 5% to about 50% by weight of said total weight of said inhibitor composition.

20. The method of claim 19 wherein said inhibitor composition further comprises:
tetraethylenepentamine (TEPA) in an amount of from about 1% to about 15% by weight of said total weight of said inhibitor composition and
aminoethylethanolamine (AEEA) in an amount of from about 0.1% to about 10% by weight of said total weight of said inhibitor composition.

21. The method of claim 20 wherein:
said triethylenetetramine (TETA) is present in said inhibitor composition in an amount of from about 50% to about 80% by weight of said total weight of said inhibitor composition and
said aminoethylpiperazine (AEP) is present in said inhibitor composition in an amount of from about 5% to about 45% by weight of said total weight of said inhibitor composition.

22. The method of claim 21 wherein:
said tetraethylenepentamine (TEPA) is present in said inhibitor composition in an amount of from about 2% to about 10% by weight of said total weight of said inhibitor composition and
said aminoethylethanolamine (AEEA) is present in said inhibitor composition in an amount of from about 0.1% to about 5% by weight of said total weight of said inhibitor composition.

23. The method of claim 21 wherein said inhibitor composition further comprises diethylenetriamine (DETA) in an amount of from about 0.1% to about 15% by weight of said total weight of said inhibitor composition.

24. The method of claim 21 wherein said inhibitor composition further comprises 2-piperazinoethanol in an amount of from about 0.1% to about 10% by weight of said total weight of said inhibitor composition.
